(19) United States
(12) Patent Application Publication
(10) Pub. No.: US 2010/0017148 A1
(43) Pub. Date: Jan. 21, 2010

(54) SYSTEM AND METHOD FOR MEASURING FILTER SATURATION

(76) Inventors: Albert Bos, Brummen (NL); Hendrik Oord, Zutphen (NL)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(21) Appl. No.: 12/160,571

(22) PCT Filed: Jan. 10, 2007
(86) PCT No.: PCT/NL07/00011

§ 371 Date: Nov. 7, 2008

(30) Foreign Application Priority Data
Jan. 10, 2006 (EP) 06075048.6

(51) Int. Cl. G01N 15/08; G01N 27/18; G06F 19/00

(52) U.S. Cl. 702/24; 73/31.07; 73/31.06; 73/38

(57) ABSTRACT

The invention relates to a system for measuring the saturation level of a filter comprising a parallel filter; a divider for dividing said gas flow into at least a main flow and a sub flow, wherein said main flow is fed into said main filter and said sub flow is fed into said parallel filter, wherein the volume ratio between said main flow and said sub flow is substantially equal to the filter capacity ratio and/or filter volume ratio between said main filter and said parallel filter, and a detector operatively associated with the flow coming from the main filter and/or from the discharge side of said parallel filter, for measuring the concentration of the component in said flows and detecting a difference in said concentrations. The detector is arranged for detecting the concentration of the component at a temperature higher than 100° C.

The invention relates to a system for measuring the saturation level of a filter. The invention further relates to an assembly of such a system and at least one filter. The invention furthermore relates to a method for measuring the saturation level of a filter by means of such a system.

In numerous situations, it is desirable that it can be detected whether an essential gas filter is saturated or not, thereby allowing timely replacement of this gas filter. The reason is that saturation of the gas filter normally results in malfunction of the gas filter, that is, the gas filter no longer functions properly. Filter malfunction resulting from saturation can entail (serious) adverse consequences. For instance, warships are typically equipped with one or more protection filters to resist a chemical and/or biological attack. By means of the protection filter, air drawn in from the outside atmosphere can be purified of noxious components before being passed into the ship. However, in case of saturation of the protection filter, the air drawn in will not be purified of noxious components, so that these noxious components will end up in the warship, which can entail serious health risks. To eliminate these risks, early detection of saturation of a protection filter is of particularly great importance.

Directly coupling an analytic device, such as e.g. a gas chromatograph, to the protection filter normally does not provide an adequate solution for early detection of filter saturation, since such a device has not been calibrated at the (varying) physical and chemical conditions of the air flow at the time of filter saturation, which is disadvantageous to the measuring sensitivity, as a result of which filter saturation can be observed only with (undesirable) delay. Moreover, analytical measurement of noxious components in the air flow coming from the filter does not provide an early warning system for an upcoming filter saturation.

The object of the invention is to provide an improved measuring system, which enables quicker detection of filter saturation.

It is a further object of the invention to provide an improved measuring system, which enables determination of the level of filter saturation

To that end, the invention provides a system for detecting saturation of a main filter for substantially removing at least one component from a gas flow, said system comprising:
a parallel filter, said parallel filter being arranged for removal of the same component from said gas flow as the main filter and having a filter capacity or filter volume that is a fraction of the filter capacity or filter volume of the main filter;
a splitter for dividing said gas flow into at least a main flow and a sub flow, wherein said main flow is fed into said main filter and said sub flow is fed into said parallel filter, wherein the volume ratio between said main flow and said sub flow is substantially equal to the filter capacity ratio and/or filter volume ratio between said main filter and said parallel filter,
a detector operatively associated with the flow coming from the main filter and/or discharge side of said parallel filter and with the flow through said parallel filter in at least one intermediate position between the proximal and distal end of said parallel filter as seen in the direction of the gas flow, for measuring the concentration of the component in said flows and detecting a difference in said concentrations wherein the detector is arranged for detecting the concentration of the component at a temperature higher than 100° C.

At an elevated temperature, a difference in thermal and/or electrical conductivity can normally be sensed better in the sensor.

The divider may be formed by arranging that the gas flow is separated into a main flow and a sub flow by means of a splitter, a fork or branching in the conduit or passageway through which the gas flow passes towards the main filter, so that a minor portion of the gas that flows towards the main filter is directed into a secondary passageway so as to form a sub flow which is fed into the parallel filter. Alternatively, the divider may physically separate the main flow feed from the sub flow feed, such that, for instance, both main and sub flow are sampled from the same gas source but use separate feeds or intake openings for taking in the gas.

The parallel flow may be very small in comparison to the main flow, and a small pump may for instance be used to extract a small sub flow from the inlet of the main stream.

The discharge or exhaust of the parallel flow may be rejoined with the main flow (i.e. on the input side of the main filter). This has the advantage that the integrity of the filter system as a whole, and thus the protection level, is not impaired by the parallel flow itself, since the parallel filtering process occurs upstream of the main filter. Alternatively, the discharge or exhaust of the parallel flow may be used as a relative reference (zero point). Of course, this will only provide a proper zero reference in case that the parallel filter (and thus also the main filter is not completely saturated.

It is a further advantage of the system of the present invention that it also allows for the detection of desorption of the filtered compound from the main filter, which may for instance occur when a very clean gas is passed through the main filter. In such instances, the position in the parallel filter at which the concentration of the compound equals the zero reference value will move towards the proximal end of the parallel filter.

It is still a further advantage of the system of the present invention that it may be fully supplementary to a main filtering system and may for instance be installed in addition to or supplementary to an already existing gas filtering system.

It is thus an advantage of the system of the present invention that the characteristics and specifications of the main filter do not have to be altered. For instance the information on the level of saturation of the main filter could in principle be obtained by placing sensors in the main filter system. That would however complicate the manufacturing and certification of the main filter and could possibly interfere with the filtering properties. By providing a parallel filter as defined herein with a system for detecting saturation and/or measuring the level of saturation of said parallel filter, the main filter can be used in essentially unaltered form. The parallel filter may comprise a detector operatively associated with the flow going through said parallel filter in at least two separate positions along an axis between the proximal and distal end of said parallel filter as seen in the direction of the gas flow, and which detector adapted for measuring the concentration of the component in said flow in said at least two separate positions and wherein said system comprises means for detecting a difference in said at least two concentrations.

The above assembly may thus have the form of one “long” parallel filter having for instance embedded sensors and/or semi permeable membranes along the length of the filter which allow diffusion of the compound towards externally placed sensors that are capable of detecting the compound in the gas composition at certain positions in the parallel filter. For instance a long tube may be packed with filter material and may have small diffusion holes along the length. The sensors may for instance be placed, preferably air-tight, against the tubing using membranes and o-rings.

In a preferred embodiment, the parallel filter comprises an array of at least two in-line filters, wherein the sub flow is fed into the first filter of the array of in-line filters, and wherein the referred intermediate position in the parallel filter is at least one position between the first and last filter of said array of in-line filters.

Preferably, such a position is the outflow of one or more of the in-line filters, under the proviso that when the position is the outflow of the last filter, the detector is also operatively associated with the flow coming from at least one other filter of the array of in-line filters. Thus, it is essential that at least an intermediate position before the end of the parallel filter is sampled in order to detect progressive saturation and/or measure the saturation level of the main filter.

In stead of using an outflow, one may use a semi-permeable (diffusion) membrane, for instance in the side of the filter housing as a part of the detector, through which membrane the component(s) from a gas flow may diffuse and be detected. The skilled person will understand that this accounts for all sampling positions associated with the filters.

The array of contiguous in-line filters may consist of any number of filters above and including two, for instance 5-10, and even more filters may together form the in-line filter array. The term in-line is used herein to indicate that the outlet of a proximal filter is connected to, and allows gas flow communication with, the inlet of an adjacent, more distal filter. Although the filter capacity or filter volume of each filter in the array of in-line filters may differ, the array as-a-whole has a filter volume or filter capacity whose value in relation to that of the main filter will determine the air flow through the filter array. In a preferred embodiment, however, the filter capacity or filter volume of each individual filter in the array is substantially equal.

In a preferred embodiment, said detector is operatively associated with the flow coming from each individual filter of said array of in-line filters and are capable of measuring the concentration of the component in the flow coming from each of the individual filters of said array of in-line filters.

By taking the flow filtered by main filter and/or from the discharge side of said parallel filter as a relative reference (zero point) in case of detection of a concentration of the component in the flow coming from an intermediate position in the parallel filter, instantaneously, at least relatively quickly, and with high sensitivity, traces of the component can be detected in the gas flow captured in a proximal position of the parallel filter, which is indicative of partial filter saturation. If traces of the component can be detected at more distal positions in the parallel filter, this is indicative of higher-level filter saturation. The relative references can only be regarded as a reference for the duration of the then prevailing current conditions and physical properties of the partial flows. Upon any change of conditions, for instance during a pressure change, the relative reference will be adjusted correspondingly. The flow serving as a relative reference then has the same physical composition regarding, in particular, pressure, temperature, and possibly moisture content, as the physical composition of the flow coming from an intermediate position in the parallel filter serving as a sample, so that the presence of a minimal amount of the component to be actually removed by the filter can be observed real-time and truly.

The observable concentration of the component depends on the nature of the component. Normally, in the case of inorganic compounds, such as H₂S and NH₃, concentrations from about 20 ppb can be observed relatively fast and readily by means of the system according to the invention; in the case of organic compounds, in particular hydrocarbons, concentrations can be observed from 50 ppb to from 1 ppm, depending on the nature of the organic compound.

The parallel filter is adapted to the main filter in that the parallel filter is arranged for removing from the gas flow the same component or group of components as the component or group of components that can be removed by the main filter. Already at relatively low flow rates of the gas flow of upwards of about 1 ml/minute, saturation of the filter can be established (depending on the capacity/flow factor with the main filter).

It will be clear that not the complete gas flow exiting from any of the filter needs to be used for detection of possible saturation of the filter. Normally, only a fraction of the exiting gas flow will be captured and be analyzed by means of the system according to the invention.

The gas flow can suitably be captured at an intermediate position in the parallel filter, i.e. at a point upflow from the regular discharge side of the filter, in order to establish the saturation level of the parallel filter, and thereby estimate the saturation level of the main filter. However, since the dimensioning of filters is normally standardized, and hence is little flexible, the gas flow will normally be captured on a regular discharge side of the first and/or an intermediate filter in the parallel in-line filter array. With the system according to the invention, saturation of a filter can thus be detected and quantified relatively simply, early and reliably.

Each of the gas flows in aspects of the present invention can be divided into a multiplicity of partial flows or main flows and sub flows. However, in order to keep the system relatively simple in construction, the divider is preferably arranged for dividing the gas flow into two partial flows. One of the partial flows is then passed through the main filter, thereby allowing the necessary reference data to be collected, while another partial flow is passed to the inlet of the parallel filter. Still another partial flow may be passed directly to the detector, thereby allowing determination of a possible presence of a component to be filtered.

The filters used in aspects of the present invention may consist of absorption filters, such as carbon filters. However, for certain applications, and when filtering floating microparticles (aerosol) from the partial flow, it is also conceivable that filters of a different kind are used, such as, for instance, a ‘High Efficiency Particulate Air’ filter (HEPA filter).

In order for the situational conditions to vary as little as possible, thus enabling optimization of the sensitivity of the system so that instantaneous detection of filter saturation and accurate measurement of saturation level can be realized, the partial flows are preferably passed in turn along the same sensor or set of sensors. To that end, the system preferably comprises a switch for passing the partial flows in succession to the detector.

The switch can then be provided with a control valve which may or may not be manually controllable. However, by preference, the switch are electronically operable, whereby the switch can be periodically switched upon lapse of a specific period of time, preferably after 10 to 15 seconds, so as to enable another partial flow to be passed through the detector.

In another particular preferred embodiment, the detector comprises several sensors, the sensors being positioned such that each partial flow is provided with at least one separate sensor. Several partial flows can then be passed simultaneously along (separate) sensors or sets of sensors, which normally makes the use of switch redundant. Moreover, the sensors can then be adjusted to the nature of the component(s) to be detected, so as to enable optimization of the analytic power of the system according to the invention.

Normally, the amount of oxygen needed for the oxidation reaction will be present in excess. However, it is conceivable that an additional, predefined amount of oxygen is supplied to the partial flow before it is passed through the sensor, to enable complete combustion of the component to be detected.

To enable a comparison of the data collected during detection, the system preferably comprises a processing unit for comparing the detected concentrations of the component in the different partial flows. More preferably, the processing unit, typically also referred to as processor, is further arranged for driving different component parts of the system, such as, for instance, control valves which may or may not be electronically controllable. In that case, the system, being provided with a processing unit designed as a driving unit, can function completely autonomously, allowing a comparison between the measured concentrations in the different partial flows to be performed independently.

Normally, the processing unit will be coupled to a database in which data collected in the past are stored for pattern recognition of the detector. During detection of the partial flows, the observed detection patterns can be compared with previously stored patterns, so that the observed detection patterns can be mutually compared relatively reliably, leading to relatively early determination of any saturation of the filter.

To enable a warning to be delivered when saturation of the filter is being established, the system is preferably provided with a signal generator for generating an audio and/or visual signal. It is also conceivable, however, that the system comprises transmitter for communicating collected data to remotely positioned receiver. In this way, it can be observed remotely when a situation of filter saturation occurs, which is advantageous in particular to warn emergency services as soon as possible after filter saturation has been established, whereupon the saturated filter can be replaced and/or measures of a different nature can be taken.

The invention further relates to a method for detecting saturation of a main filter by using a system as described above.

By using, for example, a parallel filter array consisting of 5 filters in-line filters, detection of a concentration difference between the concentration of the compound in the outflow from the main filter and in the outflow of filter 1, but not in the outflow of filter 2, is indicative of a 20% saturation of the main filter. The level of saturation may be determined more accurately by increasing the number of filters in the parallel filter array. It will be understood that the same may be performed when using a single parallel filter, but that the measurement should be performed at some measurable intermediate position between the front and back of the filter in order to calculate the level of saturation of the main filter.

The calculation of the level of saturation of the main filter has become possible due to selecting the filter capacity or filter volume of the parallel filter or parallel filter array as a defined fraction of that of the main filter, and adjusting the volume of the sub flow relative to the volume of the main flow of the gas such that the flow through the parallel filter is proportional to its filter capacity or filter volume.

The quotient of filter capacity (e.g. grams of substance that can be adsorbed before saturation of the filter occurs and expressed as grams of gas “x” per volume or weight of filter material “y”) and flow is preferably equal for both main and parallel filter. If the capacity of the parallel filter is 1/1000th of the main filter, then the flow through the parallel filter must be 1/1000^{th} also in order to achieve the same degree of saturation over time. When using the same filter material, the volume/weight of the filter material can be taken instead of the capacity, as the capacity will have a linear relationship with the volume/weight of material.

When the parallel flow is much smaller than the main flow, a practical method is to use a diaphragm pump (e.g. similar to aquarium air pump) and directly take the air from the inlet of the main filter (which has a known flow, such as for example 600 m³/hr) pump this through the parallel filter and discharge the outlet of the parallel filter in front of the main filter again. The latter preferably does not compromise the protection of the main filter.

By increasing the precision of the various flow rates, the calculation of the level of saturation of the main filter can be increased.

In the method of the present invention, detection on the main and parallel filter is preferably performed simultaneously. In that case, however, use must be made of separate sensors. In case use is made of a collective sensor or set of sensors, detection is preferably performed in succession. The successive detection of the concentration of the component in the different partial flows can be realized by the use of switch, such as, for instance, a control valve, which may or may not be electronically operable.

In a particular preferred embodiment, detecting the concentration of the component in the flows is done at increasing temperatures from substantially 100° C. to substantially 600° C., preferably from substantially 150° C. to substantially 550° C. The increase of this temperature proceeds within a particular time frame, for instance 10 seconds. Since the detection of the nature of the component is normally temperature-dependent, it is advantageous to measure over a particular temperature range in order to make the analytic picture of the components contained in the partial flow as complete as possible.

Preferably, the detector comprises a semiconductor sensor on a micro-hotplate where chemical reactions occur of the traces to be detected. Such detector exploits the variation of electrical resistance of the sensor while, at a certain heating temperature, redox reaction take place on the surface of the sensor. Such hotplate technology is very sensitive to variations of the temperature and it is therefore preferably, detection is provided of the traces at a prefixed temperature. In particular, the heater resistance is temperature dependent, which implies that current adjustments may be provided to provide a stable temperature. This can be done by a balancing circuit which balances the heat resistor to a predefined resistor value.

Hence, for different sensors, a certain chemical substance may be sensed at varying temperatures caused by the differing offsets of the heater elements, which may give rise to a differing detection results for the various sensors. Therefore, to provide a reliable sensor with replicable results, from which sensor results can be coupled to a standardized database comprising footprints of identified chemical compositions or substances, the temperature relation is important.

In particular, in one aspect, the invention provides a system of the above described type, comprising a test circuit for measuring a dissipated power in the heater element and for calculating a real temperature from the dissipated power in the heater element based on the predetermined power-temperature characteristic. Accordingly, a deviation of less then 1-1.5° C. from a preset temperature can be attainable using standard components. Thus it is possible to provide a low cost sensor which is easily resettable in neutral conditions. This can be typically done in a factory setting or rather by a user who needs to reset the sensor in a certain conditioned gas ambiance. In this way there is provided an automatic calibration facility on board of the sensor, which by placing it in a neutral ambiance, can easily tune the adjustable resistor to provide a real temperature.

U.S. Pat. No. 4,847,783 discloses a balancing circuit comprising an adjustable resistor for tuning the heater element to a predefined resistor value.

The invention will now be clarified on the basis of non-limiting exemplary embodiments represented in the appended drawing. In the drawing:

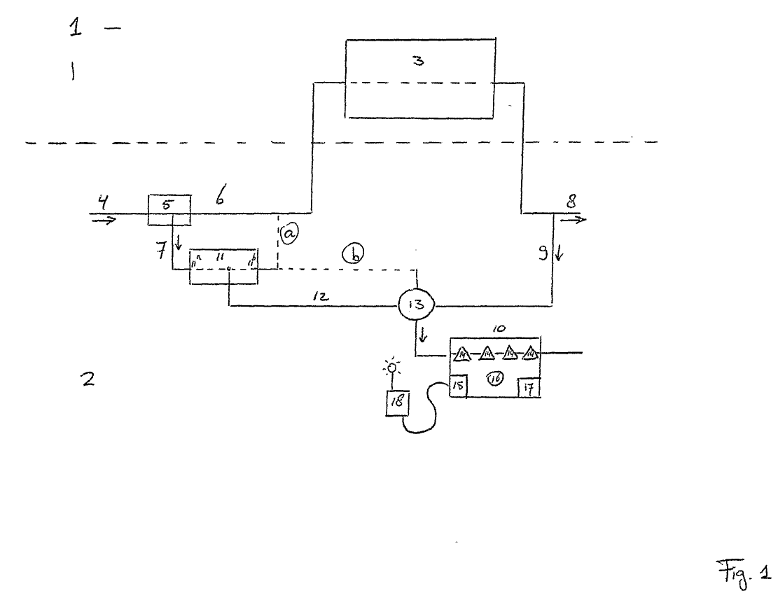

FIG. 1 is a diagrammatic representation of an assembly of a system according to the invention and a filter,

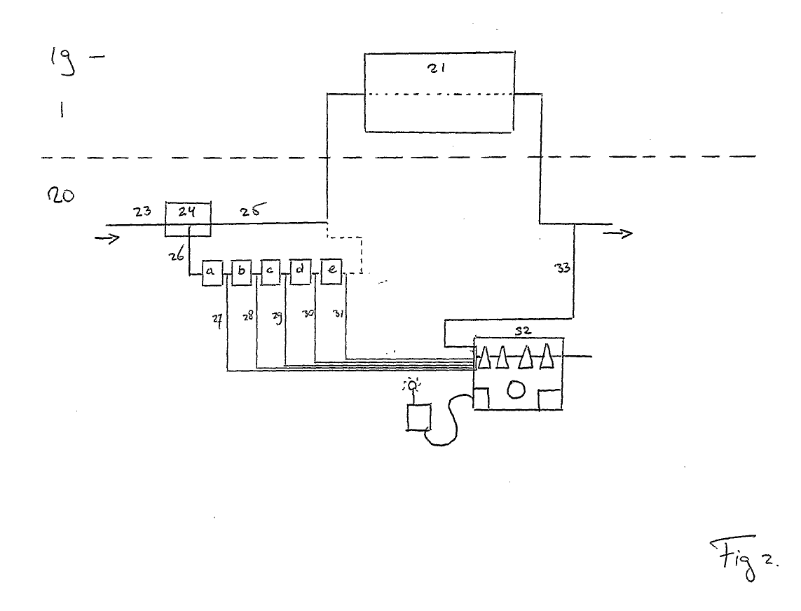

FIG. 2 is a diagrammatic representation of an alternative assembly of a system according to the invention and a filter.

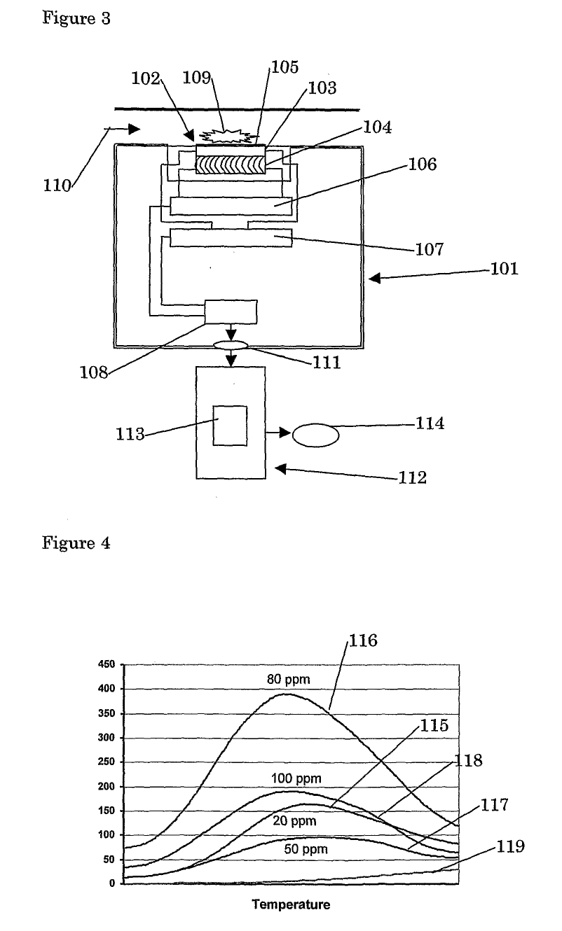

FIG. 3 shows a typical layout of the gas sensor according to the invention;

FIG. 4 shows a response characteristic of a heatable metal oxide sensor that is exposed to a variety of compositions or chemical substances in varying concentrations;

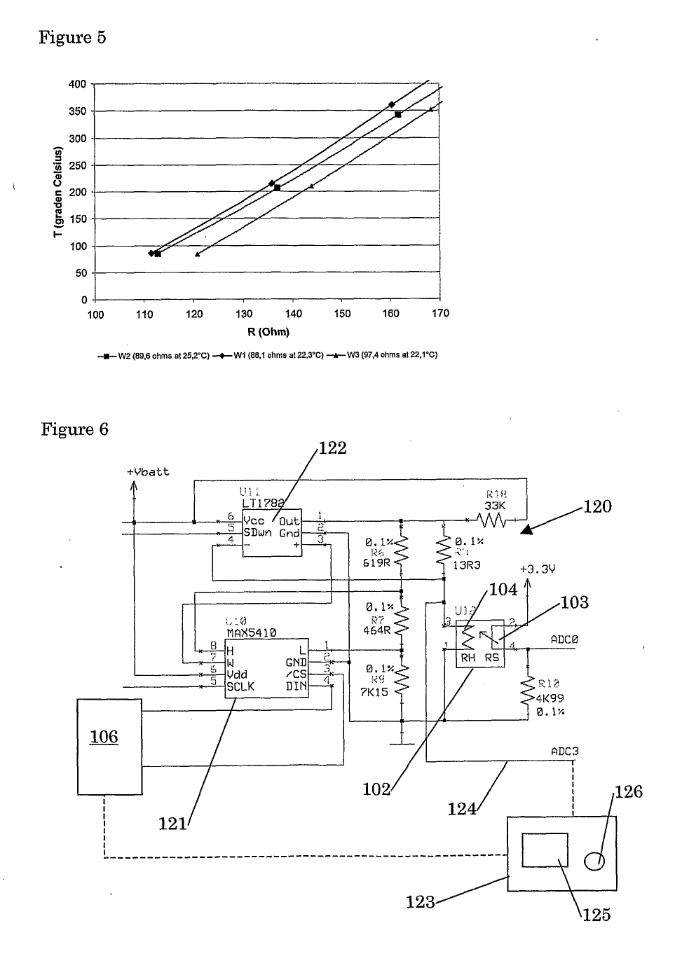

FIG. 5 shows measured resistance-temperature diagrams of three hotplate sensors;

FIG. 6 shows a preferred embodiment of the inventive concept; and

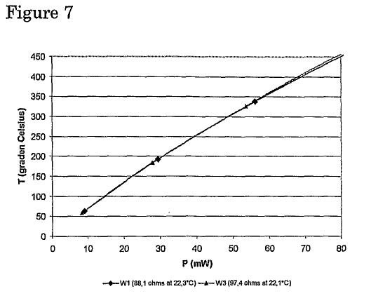

FIG. 7 shows power temperature relationships for the same heater elements as in FIG. 5.

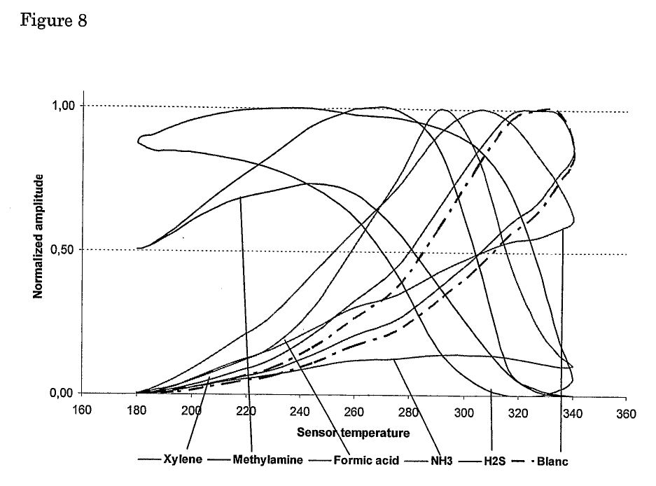

FIG. 8 shows a detector response for a thermal cycle.

FIG. 1 shows a diagrammatic representation of an assembly 1 of a system 2 according to the invention and a main filter 3. The main filter 3 can for instance be formed by a protection filter and/or industrial filter. The system 2 is arranged for detecting and/or quantifying saturation of the main filter 3 and hence malfunction of the main filter 3. Normally, a gas flow 4 will be passed through the main filter 3. Before the gas flow 4 enters the main filter 3, it is passed to a dividing unit 5, where the gas flow 4 is divided into a main flow 6, and a sub flow 7. Main flow 6 is passed through the main filter 3, where a component or group of components is removed. A clean gas flow 8 exits main filter 3 to serve as a clean supply of gas and a gas fraction 9 is captured by conventional means (not shown). The gas fraction 9 is passed to a detection unit 10 to provide a reference value (zero point). Sub flow 7 is passed through a parallel filter 11 and a gas fraction 12 is captured by conventional means (not shown) at an intermediate position between the proximal end (11a) and distal end (11b) of the parallel filter (11). The gas filtered through the parallel filter may be either rejoined (a) with the main gas flow 6, or may be used (b) to provide an alternative reference value (zero point). Both the gas fraction 9 and the gas fraction 12 are passed to an electronic switch 13. In succession, the two gas fractions 9 and 12 are furthermore passed to a detection unit 10, in order to observe any critical difference in concentration of the above-mentioned component or group of components between the two gas fractions 9 and 12. The detection unit 10 in this exemplary embodiment comprises four metal oxide sensors 14, along which the gas fractions 9 and 12 are passed in alternation. During analysis of each gas fractions 9 and 12 by the sensors 14, the sensors are heated from about 150° C. to about 550° C., in order to observe as many components as possible in a reliable manner. Since the situational conditions, in particular regarding physical parameters, such as pressure and temperature, of gas fraction 9 serving as a reference and gas fraction 12 serving as a sample are identical, relatively low concentrations of less than 1 ppm can be measured relatively quickly and reliably with a relatively high sensitivity. The detection unit 10 further comprises a processing unit 15, a database 16, and a supply 17, thereby allowing saturation of the main filter 3 to be established and/or quantified fully autonomously. When saturation of the main filter 3 has been established and/or quantified to reach a certain level, a signal can be transmitted via a transmitter 18, for instance to a maintenance service, whereupon the main filter 3 can be cleaned and/or replaced.

FIG. 2 shows a diagrammatic representation of an alternative assembly 19 of a system 20 according to the invention and main filter 21. A gas flow 23 to be passed through the main filter 21, is passed to a dividing unit 24, where the gas flow 23 is divided into a main flow 25, and a sub flow 26. Main flow 25 commences as described in FIG. 1. Sub flow 26 is passed through a series of 5 aligned filters (a-e). Gas fractions 27, 28, 29, 30 and 31 are captured and all are passed to a detection station 32 (same configuration as detection unit 10 of FIG. 1, except for having multiple gas inputs), where the gas fractions can be subjected to component (group)-specific analysis. The detected data can subsequently be compared with the data obtained from the reference gas fractions 31 or 33. When gas fractions 27 and 28 have a higher concentration of component(s) than any of the reference value(s) (e.g. gas fraction 31 or a gas fraction 33 from the gas flow filtered through the main filter), it can be established that the main filter has a saturation level of at least 40%.

Turning to FIG. 3 a typical layout is shown for a detection unit, in particular detector 101 implementing a heatable conducting plate 102, also known as hotplate sensor 102. The hotplate sensor 102 is typically provided by a metal oxide sensor element 103 which is sensitive to chemical reactions taking place near the sensor surface area, that is in close spatial relationship with a heater element 104. This sensor element 103 shows in particular a variation in conductance depending on chemical traces reacting near the exposed surface area 105 thereof. Various metal oxide sensor elements 103 are known, including but not limited to tin oxide, zinc oxide, iron oxide and tungsten oxide sensors with or without added catalyst, including but not limited to platinum and paladium.

The hotplate 102 is heated by a heater element 104 which is preferably attached in close vicinity of the sensor element 103 produced by MEMS (micro electrical mechanical systems) technology thus ensuring an identical temperature of the conducting sensor element 103 and the heater element 104. The heater element 104 has a low thermal mass and is controlled by a processor 106 for to provide a stabilized temperature in said sensor element 103. Typically this is provided by a balancing circuit implementing a Wheatstone bridge as will be further elucidated in FIG. 6.

Furthermore, the sensor element 103 is connected to a detection circuit 107 for detecting a change of resistance in the sensor element 103 in accordance with the presence of a chemical trace reacting in the presence of the conducting plate. The output of the detection circuit 107 in connection with a preset temperature provided by the processor 106 are stored in an internal memory element 108 of the detector, which can be any type of memory , typically a flash memory.

In the memory element 108, among others, a plurality of detected resistance values in the detection circuit relative to a plurality of preset temperatures can be stored to form a footprint of a number of chemical substances 109 which are sensed by the hotplate 102 by exposing the hotplate to a flow of gas 110. Alternatively, the hotplate can be subjected to stagnant air.

In the embodiment shown, the results are stored in the memory element 108 to be transmitted via a communication terminal 111 to a base station 112 comprising a database for storing footprints of predetermined chemical substances. Thus the stored footprints can be communicated to the base station 112 comprising a database 113, for providing a best match 114 of any of said stored footprints in the memory element 108 to any of footprints stored in the database 113 of known chemical substances. In this way a particular detected composition of chemical substances can be identified in the database 113 via per se known pattern recognition and identification software techniques.

Although in this embodiment, the identification of a sensed chemical composition can be done online or offline in an external base station 112, the detector 101 may also be equipped with specific matching routines which can match the detected footprint with one or more predefined chemical substances on board of the detector 101. In this way, the detector 101 can be easily modified to provide a detector for detecting specific predetermined chemical substances. In this (not shown) embodiment, the detector 101 hence comprises in addition a comparison circuit for comparing a stored footprint with a predetermined set of prestored footprints of predetermined chemical substances, so as to determine a particular detected chemical substance.

FIG. 4 shows different conductivity responses of the hotplate 102, in particular, for a concentration of 20 and 80 ppm (line 115 and 116 respectively) of toluene and for a concentration of 50 and 100 ppm (line 117 and 118 respectively) of butyl acetate. Also a blank response 119 is shown, illustrating a detected conductance for varying temperatures. The typical detection temperatures vary between 200 and 600° C. It can be shown generally that the metal oxide sensor produces peak conductance values for different chemical substances on different temperature values and for different peak values. For example, the conductance for toluene is generally higher than for butyl acetate. However, it is clear that when a precise temperature setting is unknown, the discriminatory power between 20 ppm toluene and 100 ppm butyl acetate is poor, even when a test is conducted at various temperatures. Therefore, an accurate setting of the temperature is important for obtaining reliable test results.

Typically, the metal oxide sensor 102 is sensitive for oxygen reducible substances. Typically, components show maximum conductance according to particular temperatures settings. By obtaining the detection results at various temperature, a footprint can be obtained of the variety of chemical substances. This footprint can be compared to a number of footprints of known pure substances or mixtures that are stored in a database 113 as referred to in FIG. 3.

FIG. 5 shows a measured resistance-temperature diagram of the heater element 104. As will be further elucidated with reference to FIG. 6 the heater element 104 can be integrated in a balancing circuit to preset the resistor value thereof to a predetermined value. Thus, a balancing circuit can provide a preset resistor value of the heater element 104, giving rise to a predetermined temperature according to the resistance-temperature diagram shown in FIG. 5.

However, the diagram in FIG. 5 clearly shows that the temperatures of the hotplate 102 are varying substantially for a preset resistor value. For three hotplates W1, W2, W3 shown, the hotplates W1 and W2 are of a same type. This means that the macroscopic dimensions of the heater elements 104 are almost the same. Nonetheless, where the resistance varies only 1.5 Ohm at room temperature, at a preset resistance of 160 Ohm a difference of 25° C. is provided by the heater element. It shows that without individual calibration of the heater element 104, presetting the heater element 104 to a fixed resistance can give an unacceptable spread in temperatures, which affects the reliability of the detector 101.

FIG. 6 shows a preferred embodiment of the inventive concept. In particular, FIG. 6 shows a processor 106 and a balancing circuit 120 having an adjustable resistor 121 for tuning the heater element 104 to a predefined resistor value.

The balancing circuit 120 comprises essentially a Wheatstone bridge arrangement of fixed resistors R5, R6, R7, R8, in combination with a heatable resistor 104 (also indicated in the drawing as RH) and a tunable digital potentiometer which functions as the adjustable resistor 121 (also indicated in the drawing as U10). The digital potentiometer 121 has a very good linearity. The resistance in the bridge circuit 120 is determined by the resistor R8 circuited parallel to the digital potentiometer 121. This resistor R8 (as well as the other fixed resistors R5, R6 and R7) has a very precise resistive value, typically with a margin of error of less than 0.1%. The circuit is balanced by the operational amplifier 122 (U11) which controls the voltage across the heater element 104. In particular, the amplifier U11 will control the Voltage between the + and − terminals of the amplifier so that there is no voltage difference, i.e. so that the bridge is balanced. When the Voltage difference is higher, the current through the heater element 104 (RH) will increase. The heater element 104, conducting an increased current, will heat up and the resistance will rise accordingly. Accordingly a preset resistive value of the heater element 104 can be controlled, wherein the resistive value of the heater element 104 is known expressed as a ratio of resistive values of the R5, R6, R8, and a fraction of R7 determined by tunable digital potentiometer 21 (also indicated in the drawing as U10)

In addition, FIG. 6 shows a test circuit 123 for the balancing circuit 120 for measuring a dissipated power in the heater element 104 and for calculating a real temperature from the dissipated power in the heater element 104 based on the predetermined power-temperature characteristic which will be further elucidated with reference to FIG. 7.

In this embodiment the test circuit 123 comprises a pair of test terminals 124 (one being grounded) that directly connect to the terminals of the heater element 104. This arrangement provides a conveniently implementable circuit 121 for calculating the power dissipation in the resistor using the familiar formula V_{H}²/R_{H} with V_{H} being a detected voltage difference across the heater element 104. In addition, R_{H} indicates a true resistive value of the heater element 104 derived from the balancing circuit 120.

In one embodiment, the test circuit 123 comprises a calculating circuit 125 to calculate an offset value for the digital potentiometer 121. In particular, the test circuit 123 comprises a switch 126 to activate the calculating circuit 125. In this embodiment, the test circuit 123 measures a dissipated power in predefined neutral conditions.

Upon activation, a method of calibrating the hotplate chemical trace detector 101 is carried out. In particular, using the test circuit 123 there is provided a predetermined power level to the hotplate 102 by adjusting the adjustable resistor 121. When the sensor is placed in a neutral ambiance the predetermined power level can be related to a set temperature using a known power-temperature characteristic of the heater plate. Thus, a precise set-point for a predetermined number of temperatures can be provided to the processor 106 for the heater element 104, thus zeroing the adjustable resistor 121 to a preset value relating to the set temperature.

In another embodiment, the test circuit is connectable to a calibration circuit for providing a lookup table to the processor 106 for calculating preset resistor values so as to provide predetermined real temperatures to said heater element. In this embodiment, the detector 101, in particular, the processor 106, may be attached to a separate test circuit 123, for instance, in a factory setting, indicated by the dotted lines 127. In predefined neutral conditions, a series of predetermined power settings to the heater element 104 is provided by adjusting the adjustable resistor 121. Accordingly a series of predetermined temperatures to these power settings is provided using the power-temperature characteristic of the heater plate. In this way a series of setpoints for setting a temperature can be provided to form a lookup table to the adjustable resistor 121 for providing preset resistor values so as to provide predetermined real temperatures to said heater element 104. The lookup table is then integrated in the processor 106, in particular, is provided in a local memory to be accessed when setting the adjustable resistor to a predetermined temperature setting.

With the hotplate chemical trace detector as here above described, a precise temperature of the heater element 104 can be measured by the test circuit 123, without having to rely on the resistance-temperature characteristic of the heater element that may vary from sample to sample. In particular, a precise set point for the heater element can be provided.

Thus, when using this setpoint, a temperature can be set by adjusting the resistor in the balancing circuit to a real known temperature. The amount of power to achieve this temperature can be related to a dissipated reaction energy of the chemical trace. Indeed, the calculating circuit 125 can be arranged to calculate a difference of a measured input power from the test terminals 124 and a calculated input power. This calculated input power can for instance be provided using the known real temperature derived from the preset resistor value 121 after calibration and relating it to a calculated power in the heater element 104 using the power-temperature characteristic of the heater element 104.

In this way, a new way of characterizing chemical substances can be provided, whereas, in addition to a measured conductance of the sensing element 103.

In another embodiment, a dynamic temperature modulation is used of the hotplate 102. In this embodiment, the processor 106 is arranged to provide a sliding temperature to the heater element 104. Thus, by providing a predefined dynamic temperature profile to the heater element 104 and deriving a sensed conductance of the sensor element 103, more information can be collected from the sensor to provide it to pattern recognition software implemented in the database 113, which for this purpose stores conductance diagrams of predefined chemical substances measured in standard conditions as a function of known real temperature and temperature dynamics.

FIG. 7 shows a power-temperature characteristic for two macroscopically identically hotplate sensors 102. The term macroscopically identical indicates a generally identical geometric structure for the hotplate 102, that is, a generally identical conducting structure for conducting heat from the heater element 104 and the sensor element 103. The power-temperature characteristics for the two heater elements W1 and W2 appear to be substantially identical although heater element W1 shows a resistance of 88.1 Ohm at 22.3° C. and heater element W3 shows a resistance of 97.4 Ohms at 22.1° C., a difference of more than 10%. The power-temperature characteristic is valid in standard conditions, at room temperature in clean air. In non-standard conditions the actual temperature can be measured and used for recalculating the power-temperature characteristic. In this way, the temperature of the heater element 104 Tₛₑₙₛₒᵣ can be derived for a predetermined number of settings of the digital potentiometer 121 Rₚₒₜ. This provides a gauge line which can be converted to a function using a linear regression.

Rpot=F(Tₛₑₙₛₒᵣ) [1]

This equation can be implemented in software operating the processor 106 so that a temperature can be preset with a deviation which may be less than 3-5° C.

FIG. 8 shows a detector response for a thermal cycle, that is, for a detector that is arranged to increase a sensing temperature of the detector, in particular, of the hotplate 102 from substantially 100° C. to substantially 600° C. while measuring a sensor response. To this end, a normalized amplitude is shown on the Y-axis of the graph; wherein a thermal cycle is passed by a temperature that varies substantially sinusoidal in time. This response is preferably fixed within a predetermined time frame, of substantially a few seconds, typically from about 5 to 45 seconds.

A normalized amplitude can be a good measure for a typical detector response to various gaseous substances; responses are shown for various substances, in particular, Xylene, Methylamine, Formic Acid, NH3 and H2S. For reference, a blanc response is also shown.

Due to dimensional differences, and also due to varying gas concentrations, a typical response will vary from detector to detector. By normalizing the amplitude the amplitude can be made substantially invariant, so that a temperature cycle form is indicative of a typical substance, irrespective of dimensioning and concentration variations.

In another embodiment, a non-normalized amplitude can be made indicative of a gas concentration, provided it is calibrated.

By providing a predetermined temperature, the curve as depicted in FIG. 8 will not vary due to temperature differences, so that good comparison can be made with prestored temperature responses.

Thus, by providing temperature-calibrated detectors, a detected temperature response can be normalized and then analyzed. The presence (typically, irrespective of concentration) of a particular gaseous substance can then be indicative for a filter wear out. Alternatively, any significant deviation from a normalized clean air response can be used if no particular gaseous substance is known beforehand.

Although the thermal cycle response of FIG. 8 is a result of a sinusoidal temperature variation, other types of variations can be applied as well, such as linear variation or block variations etc. The loop hysteresis of the loop, which is related to a loop form, will be typically time dependent, so that the temperature variation is preferably kept fixed for ease of comparison. A typical repetitive temperature variation will result in a generally repetitive detector response, so that, in particular, for continuous sinusoidal temperature cycles subsequent measurement cycles will align.

In conclusion, the loop hysteresis, and thus a temperature cycle response will be a function of gaseous substance and the time cycle (limit value and change velocity) of temperature variation.

Although the invention has been set forth using a limited number of embodiments the skilled person will appreciate that various modifications and adaptations thereto are possible without departing from the scope of the invention. For instance, it is possible to derive the power dissipated in the heater element by a test circuit 123 coupled more indirectly to the heater element, for instance a terminal that measures the output voltage of the amplifier U11 of FIG. 6. Alternatively, or in addition the test circuit 123 that does not need to use the balancing circuit 120 but could measure the resistance of the heater directly using a preset value of the digital potentiometer 121.

The invention is not limited to the disclosure of the embodiments shown in the description but encompasses variations and modifications thereto and is determined by the scope of the annexed claims and their equivalents.

1. A system for detecting saturation of a main filter for substantially removing at least one component from a gas flow, said system comprising:
a parallel filter, said parallel filter being arranged for removal of a same component from said gas flow as the at least one component removed by the main filter and having a filter capacity or filter volume that is a fraction of a filter capacity or filter volume of the main filter;
a divider for dividing said gas flow into at least a main flow and a sub flow, wherein said main flow is fed into said main filter and said sub flow is fed into said parallel filter, wherein a volume ratio between said main flow and said sub flow is substantially equal to a filter capacity ratio and/or filter volume ratio between said main filter and said parallel filter, and
a detector operatively associated with a filtered gas flow coming from the main filter and/or from a discharge side of said parallel filter and with a partially filtered gas flow through said parallel filter in at least one intermediate position between a proximal end and a distal end of said parallel filter as seen in the direction of gas flow, for measuring a concentration of the at least one component in said filtered and partially filtered gas flows and detecting a difference in said concentrations;
characterized in that the detector is arranged for measuring the concentration of the at least one component in the filtered and partially filtered gas flows at a temperature higher than 100° C.

2. A system according to claim 1, wherein said detector is arranged to increase said temperatures from substantially 100° C. to substantially 600° C. while measuring a response.

3. A system according to claim 1, wherein said detector is arranged to increase said temperatures within a predetermined time frame.

4. A system according to claim 1, wherein said predetermined time frame spans 10 seconds.

5. A system according to claim 1, wherein said parallel filter comprises an array of at least two in-line filters, wherein said sub flow is fed into a first filter of said array of in-line filters, and wherein said at least one intermediate position in said parallel filter is at least one position between the first filter and a last filter of said array of at least two in-line filters.

6. A system according to claim 5, wherein said at least one intermediate position in said parallel filter is an outflow of at least one of said in-line filters, under a proviso that when said position is the outflow of the last filter, said detector is also operatively associated with a flow coming from at least one other filter of said array of in-line filters.

7. A system according to claim 5, wherein said array of in-line filters consists of from 2 to 10 filters.

8. A system according to claim 5, wherein said array of in-line filters consists of 10 or more filters.

9. A system according to claim 5, wherein the detector is operatively associated with a gas flow coming from each individual filter of said array of in-line filters.

10. A system according to claim 5, wherein a filter capacity or filter volume of each filter of said array of in-line filters is substantially equal.

11. A system according to claim 1, characterized in that the filters are absorption filters.

12. A system according to claim 11, characterized in that the detector comprises multiple sensors, ones of the multiple sensors being positioned such that at least a main flow and a sub flow are provided with at least one separate sensor.

13. A system according to claim 1, characterized in the detector comprises a metal oxide semiconductor (MOS) sensor.

14. A system according to claim 1, characterized in that the system comprises a processing unit for comparing the measured concentrations of the at least one component in various flows.

15. A system according to claim 1, characterized in that the system comprises a transmitter for communicating collected data to a remotely positioned receiver.

16. A system according to claim 1, characterized in that the system comprises a switch for passing various gas flows in succession to the detector.

17. A system according to claim 16, characterized in that the switch is electronically operable.

18. A system according to claim 1, wherein said detector comprises:
a heatable conducting plate comprising a heater element having a predetermined power-temperature characteristic;
a balancing circuit comprising an adjustable resistor for tuning the heater element to a predefined resistor value;
a processor for adjusting the adjustable resistor so as to provide a stabilized temperature in said heatable conducting plate;
a detection circuit for detecting a change of resistance in the heatable conducting plate in accordance with the presence of a chemical trace reacting in the presence of the conducting plate; and
a test circuit for measuring a dissipated power in the heater element and for calculating a real temperature from the dissipated power in the heater element based on the predetermined power-temperature characteristic.

19. A system according to claim 18, wherein the test circuit is connectable to a calibration circuit for providing a lookup table to the processor for providing preset resistor values so as to provide predetermined real temperatures to said heater element.

20. A system according to claim 18, wherein the test circuit is coupled to a processor to calculate a dissipated reaction energy of the chemical trace as a difference in a measured input power and a calculated input power from a preset resistor value after calibration.

21. A system according to claim 18, wherein the processor is arranged to provide a sliding temperature to the heater element.

22. A system according to claim 18, wherein the test circuit comprises a pair of test terminals that directly connect to the terminals of the heater element.

23. A system according to claim 18, wherein the detector comprises a memory for storing at least a plurality of detected resistance values in the detection circuit relative to a plurality of preset temperatures to form a footprint of a number of chemical substances.

24. A system according to claim 23, wherein the detector comprises a communication terminal for communicating with a database storing footprints of predetermined chemical substances or clean air, for providing a best match of said footprint of a number of chemical substances to any of said stored footprints of the database so as to determine a particular detected chemical substance or absence thereof.

25. A system according to claim 23, wherein the detector comprises a comparison circuit for comparing a stored footprint with a predetermined set of prestored footprints of predetermined chemical substances or clean air, so as to determine a particular detected chemical substance or absence thereof.

26. A method of testing the presence of a gaseous substance, comprising:
detecting a component concentration at a detection temperature higher than 100° C.;
time-varying said detection temperature while measuring a response in order to obtain a time-varied detector output temperature cycle; and
comparing said detector output with a prestored temperature cycle that is coupled to a predetermined gaseous substance or clean air.

27. A method according to claim 26, wherein said detection temperature is increased from substantially 100° C. to substantially 600° C.

28. A method according to claim 26, wherein said detection temperature is increased within a predetermined time frame.

29. A method according to claim 26, wherein detector output is normalized.
